(19) United States
(12) Patent Application Publication
(10) Pub. No.: US 2010/0263498 A1
(43) Pub. Date: Oct. 21, 2010

(54) Swing Wrench

(76) Inventor: Ping Wen HUANG, Wurih Township (TW)

Correspondence Address: Wang Law Firm, Inc., 4989 Peachtree Parkway,, Suite 200, Norcross, GA, 30092, US

(21) Appl. No.: 12/268,519

(22) Filed: Nov. 11, 2008

(51) Int. Cl. B25B 13/20

(52) U.S. Cl. 81/170

(57) ABSTRACT

A swing wrench includes a fixing jaw, a moving jaw, an acting set, and a handle pivotally fixed to the bottom of the fixing jaw. A fixing element is disposed between the bottom of the fixing jaw and the front end of the handle. A limiting section is disposed around the fixing element. A fixing part is formed at the front end of the handle, opposite to the fixing element. The limiting section of the fixing element can engage or move away from the fixing part of the handle. When the limiting section is away from the fixing part, a swing space is formed in between for the handle to pivotally swing with respect to the fixing jaw.

### BACKGROUND OF THE INVENTION

1. Field of Invention

The invention relates to a hand tool and, in particular, to a swing wrench that has both traditional and one-way driving features.

2. Related Art

Using a normal wrench to lock or unlock a polygonal bolt, the user usually has to repeatedly remove and engage the wrench on the bolt. This is very tedious and time-consuming. In view of this, many improved wrenches have been invented to solve the problem. Consequently, the wrench can be used like a ratchet wrench; the user can conveniently swing the wrench reciprocally to lock or unlock the bolt.

The improved structure of a moveable wrench disclosed in ROC Pat. No. M300,594 is also proposed by the present inventor. It mainly includes a fixing jaw, a moving jaw, a handle, a shaft, and a blocking pin. The joint between the front end of the handle and the fixing jaw is used as the pivot point. When the user swings the handle back and forth, the handle drives the blocking pin in the fixing jaw to move reciprocally to unlock the moving jaw. The elasticity of the spring mounted on the shaft in the main groove of the fixing jaw continuously keeps the moving jaw slightly away from the fixing jaw and then back to the holding position. It thus achieves the effect of locking or unlocking a polygonal bolt in a continuous way in one time.

However, the above-mentioned wrench structure is designed to only provide the single function of rotating the bolt in one way, much like the ratchet wrench. It cannot achieve the both traditional and one-way driving features at the same time. There is, therefore, room for improvement.

### SUMMARY OF THE INVENTION

An objective of the invention is to provide a swing wrench that can restricts the swinging state of the wrench so that it has both traditional and one-way driving features.

To achieve the above-mentioned objective, the disclosed swing wrench includes: a fixing jaw, a moving jaw, an acting set, a handle pivotally fixed at the bottom of the fixing jaw, and a blocking pin. The fixing jaw has an accommodating tank. A sliding track is provided above and in communication with the accommodating tank. One side of the accommodating tank is formed with a through hole horizontally. A connecting hole is formed in the through hole in the radial direction. The moving jaw is disposed in the sliding track of the fixing jaw to move sideways along the sliding track. A tooth part is provided at the bottom of the moving jaw. The acting set is disposed in the accommodating tank of the fixing jaw. It contains a shaft and a spring. The shaft has a first end, a second end, and a middle section between the two ends. The part between middle section and the second end is slightly recessed to form a blocking part. The second end and the blocking part of the shaft go into the through hole of the fixing jaw. The blocking part corresponds to the connecting hole. The middle section of the shaft is mounted with a roller that matches with the tooth part at the bottom of the moving jaw. The spring is mounted around the middle section of the shaft, with its two ends urging against the roller and the inner wall of the accommodating tank. The blocking pin is disposed in the connecting hole of the fixing jaw. One end of the blocking pin further connects to the front end of the handle. When the front end of the handle rotates with respect to the fixing jaw, it drives the blocking pin to slide. The other end of the blocking pin thus selectively blocks the blocking part of the shaft.

The invention is characterized in that one side of the front end of the handle is formed with a fixing part; that a fixing element is inserted between the bottom of the fixing jaw and the fixing part of the handle; that the fixing element has at least a limiting section, which can lock onto or move away from the fixing part of the handle; and that a swing space forms between the fixing part of the handle and the fixing element when the limiting section moves away from the fixing part.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the first embodiment of the invention;

FIG. 2 is a three-dimensional assembly view of the first embodiment;

FIG. 3 shows the state when the limiting section of the fixing element locks onto the fixing part of the handle in the first embodiment;

FIG. 4 shows the state when the limiting section of the fixing element moves away from the fixing part of the handle in the first embodiment;

FIG. 5 shows the state when the limiting section of the fixing element moves away from the fixing part of the handle and the handle swings in the reverse direction in the first embodiment;

FIG. 6 is a three-dimensional exploded view of the second embodiment of the invention;

FIG. 7 is a three-dimensional assembly view of the second embodiment;

FIG. 8 depicts the A-A cross section of FIG. 7, showing the state of the fixing element pivotally fixed in the pivotal connection groove of the fixing jaw;

FIG. 9 shows the state when the limiting section of the fixing element locks onto the fixing part of the handle in the second embodiment;

FIG. 10 shows the state when the limiting section of the fixing element moves away from the fixing part of the handle in the second embodiment;

FIG. 11 shows the state when the limiting section of the fixing element moves away from the fixing part of the handle and the handle swings in the reverse direction in the second embodiment;

FIG. 12 is a three-dimensional exploded view of the third embodiment of the invention;

FIG. 13 shows the state when the limiting section of the fixing element locks onto the fixing part of the handle in the third embodiment; and

FIG. 14 shows the state when the limiting section of the fixing element moves away from the fixing part of the handle in the third embodiment.

### DETAILED DESCRIPTION OF THE INVENTION

The present invention will be apparent from the following detailed description, which proceeds with reference to the accompanying drawings, wherein the same references relate to the same elements.

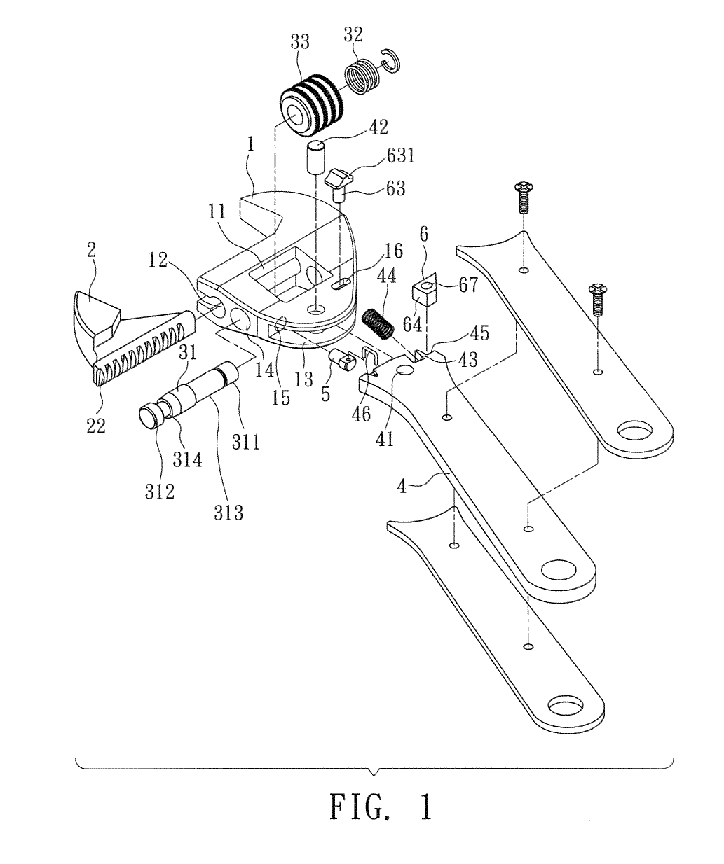

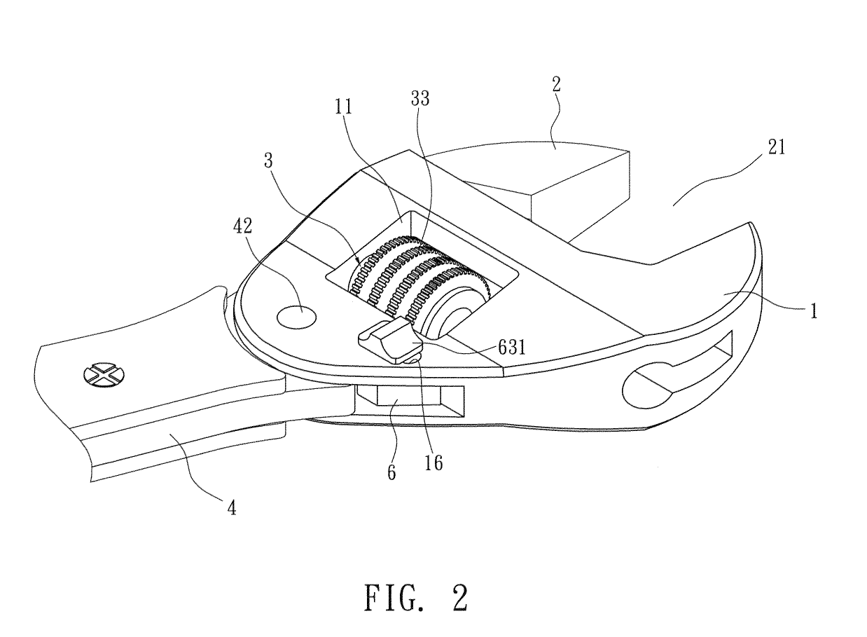

Please refer to FIGS. 1 to 4 for a first embodiment of the invention. This embodiment provides a swing wrench comprising a fixing jaw 1, a moving jaw 2, an acting set 3, a handle 4, a blocking pin 5, and a fixing element 6.

The fixing jaw 1 has an accommodating tank 11. A sliding track 12 is provided above and in communication with the accommodating tank 11. A pivotal groove 13 is formed below the accommodating tank 11, connecting to the exterior. One side of the accommodating tank 11 is formed horizontally with a through hole 14. A connecting hole 15 is formed inside the through hole 14 in the radial direction. The connecting hole 15 further connects with the pivotal groove 13.

The moving jaw 2 is disposed in the sliding track 12 to move sideways therein. The moving jaw 2 and the fixing jaw 1 form a holding zone 21 with a variable gap. The bottom of the moving jaw 2 has a tooth part 22.

The acting set 3 is disposed in the accommodating tank 11 of the fixing jaw 1. It includes a shaft 31 and a spring 32. The shaft 31 has a first end 311, a second end 312, and a middle section 313 between the two ends 311, 312. The part between the middle section 313 and the second end 312 is slightly recessed to form a blocking part 314. The second end 312 and the blocking part 314 of the shaft 31 go into the through hole 14 of the fixing jaw 1 in such a way that the blocking part 314 corresponds to the connecting hole 15. The middle section 313 of the shaft 31 is mounted with a roller 33 with a screw structure. The roller 33 matches with the tooth part 22 at the bottom of the moving jaw 2, so that the roller 33 can drive the moving jaw 2 to move sideways as it rotates. This adjusts the gap of the holding zone 21. The spring 32 is mounted around the middle section 313 of the shaft 31, with its both end urging the roller 33 and the inner wall of the accommodating tank 11, respectively.

The handle 4 has a shaft hole 41 at the front end so as to pivotally connect to the pivotal groove 13 at the bottom of the fixing jaw 1 using a pivotal axis 42. The handle 4 can expand or collapse along an arc line. A concave groove 43 is further formed at the front end of the handle 4 opposite to the pivotal axis 42 for accommodating an elastic object 44 (a spring in this embodiment). The elastic object 44 urges against the inner side of the pivotal groove 13 using its one end. Moreover, a fixing part 45 of a particular shape is disposed by the concave groove 43 of the handle 4. The opposite side to the pivotal axis 42 at the front end of the handle 4 is inserted with a buckle ring 46.

The blocking pin 5 is disposed in a slidable way in the connecting hole 15 of the fixing jaw 1. One end of the blocking pin 5 further connects to the buckle ring 46 on the handle 4. When the front end of the handle 4 pivotally rotates with respect to the fixing jaw 1, it drives the blocking pin 5 to slide. Therefore, the other end of the blocking pin 5 can selectively block the stopping part 314 of the shaft 3.

The fixing element 6 has a ladder shape and is disposed on one side of the pivotal groove 13 of the fixing jaw 1. The two adjacent planes of the fixing element opposite to the fixing part 45 are formed with a limiting section 64 whose shape corresponds to the fixing part 45 of the handle 4. The end surface of the fixing element 6 has a fixing hole 67. The outer side at the bottom of the fixing jaw 1 is formed with a sliding groove 16 corresponding to the fixing hole 67. A pin 63 goes from the sliding groove 16 outside the pivotal groove 13 into the fixing hole 67 of the fixing element 6. On the end of the pin 63 facing the outer side of the fixing jaw 1 is formed with a pushing part 631. In this way, the user can push the pushing part 631 of the pin 63 so that the fixing element 6 is driven by the pin 63 to slide along the sliding groove 16. It then locks onto or moves away from the fixing part 45 of the handle 4.

When the fixing element 6 uses its limiting section 64 to lock onto the fixing part 45 of the handle 4, the handle 4 is restricted by the limiting section 64 not to swing. When the position of the fixing element 6 is adjusted so that the limiting section 64 moves away from the fixing part 45 of the handle 4, a swing space 7 for the handle 4 to pivotally rotate with respect to the fixing jaw 1 is formed between the fixing part 45 of the handle 4 and the limiting section 64 of the fixing element 6.

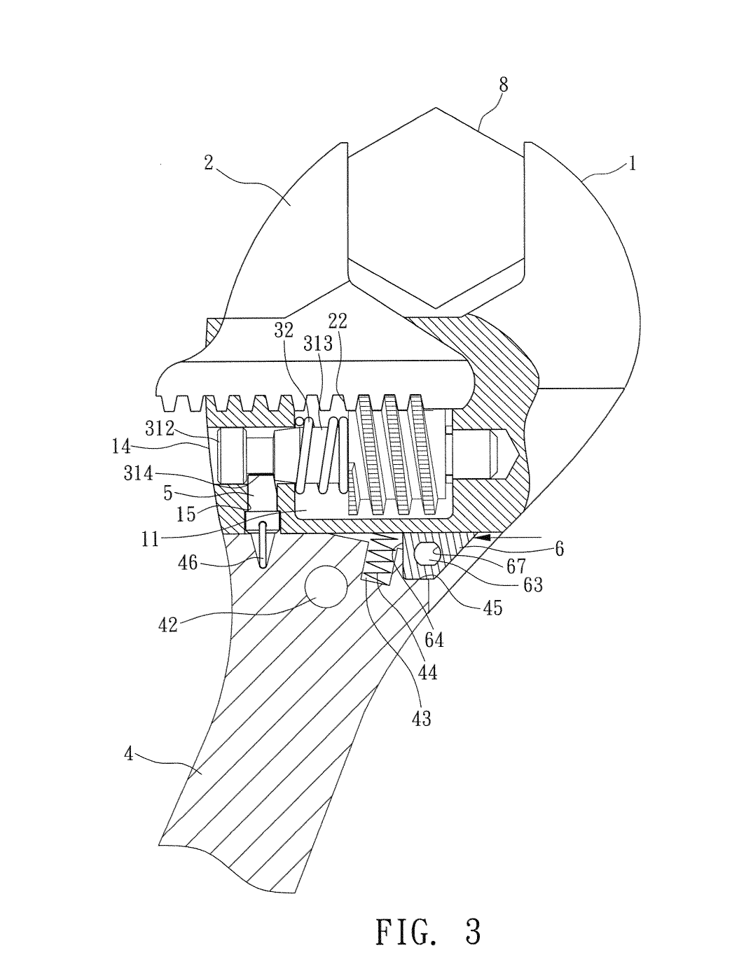

Please refer to FIG. 3. When the user wants to rotate a polygonal bolt 8, he or she first uses the roller 33 to adjust the gap of the holding zone 21 for holding the polygonal bolt 8. At this moment, the blocking pin 5 at the front end of the handle 4 engages with the stopping part 314 of the shaft 31 in the fixing jaw 1. The holding zone 21 keeps a fixed gap. When the user pushes the pushing part 631 of the pin 63 so that the limiting section 64 of the fixing element 6 and the fixing part 45 of the handle 4 match with each other, the handle 4 cannot swing with respect to the fixing jaw 1. This is because the front end of the handle 4 is restricted by the limiting section 64 of the fixing element 6. Such a design enables the invention to have the features of a traditional wrench.

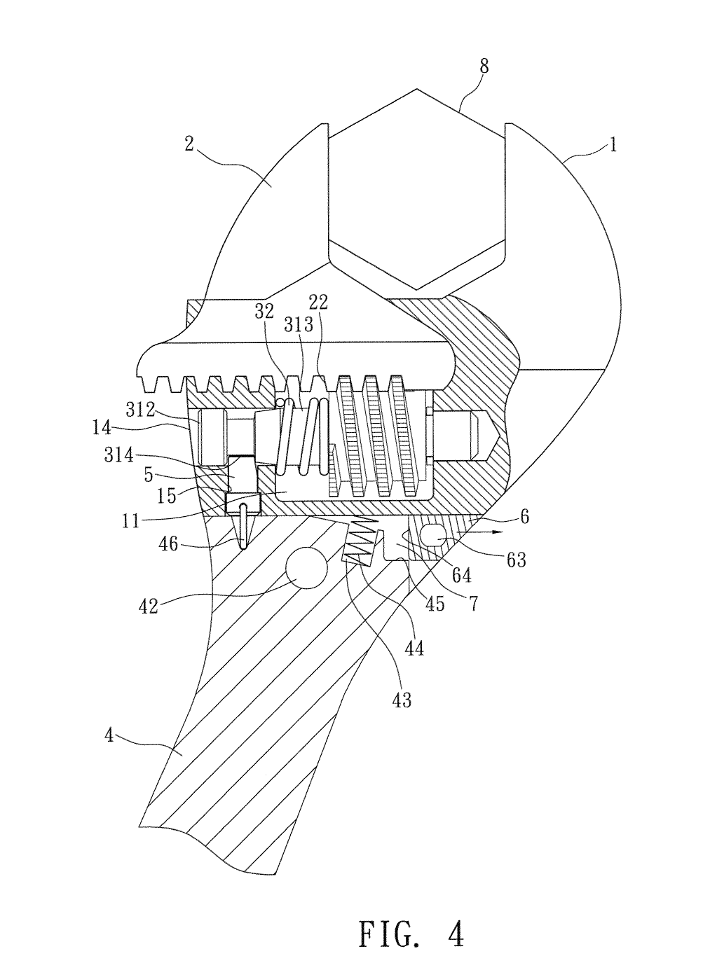

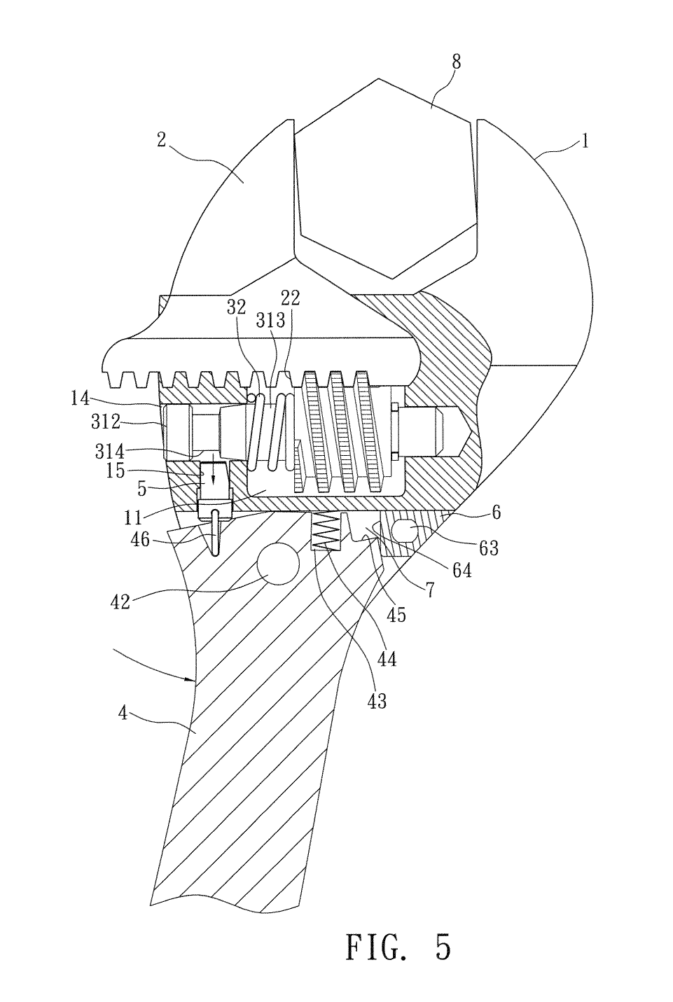

With reference to FIG. 4, when the user pushes the pushing part 631 of the pin 63 so that the limiting section 64 of the fixing element 6 moves away from the fixing part 45 of the handle 4, a swing space 7 for the handle 4 to swing with respect to the fixing jaw 1 forms between the fixing part 45 of the handle 4 and the limiting section 64 of the fixing element 6. When the user uses the pivotal axis 42 at the front end of the handle 4 as a pivot and rotates the wrench 4 in reverse direction, as shown in FIG. 5, the handle 4 swings toward the swing space 7. The elastic object 44 at the front end of the handle 4 is urged by the inner side of the pivotal groove 13 to compress. The stopping pin 5 is driven by the handle 4 to move away from the stopping part 314 of the shaft 31, no longer blocking the shaft 31. Therefore, when the front end of the moving jaw 2 is pushed by the blunt angle of the polygonal bolt 8, the moving jaw 2 and the roller 33 are pushed outward together. The spring 32 inside the accommodating tank 11 is urged by the roller 33 to compress. As a result, the gap of the holding zone 21 is slightly larger for the user to easily swing the handle 4 in reverse.

When the user rotates the wrench 4 in the forward direction, it restores as shown in FIG. 4. The compressed elastic object 4 restores due to its elasticity. The front end of the handle 4 drives and pushes the stopping pin 5 to slide to the stopping part 314 of the shaft, forming a blocking state again. The compressed spring 32 also pushes the roller 33 originally moving outward back to its original position. The holding zone 21 thus restores its original gap. The user can then rotate the polygonal bolt 8 repeatedly and continuously without moving away and engaging steps. The action of locking or unlocking the polygonal bolt 8 can therefore be readily completed.

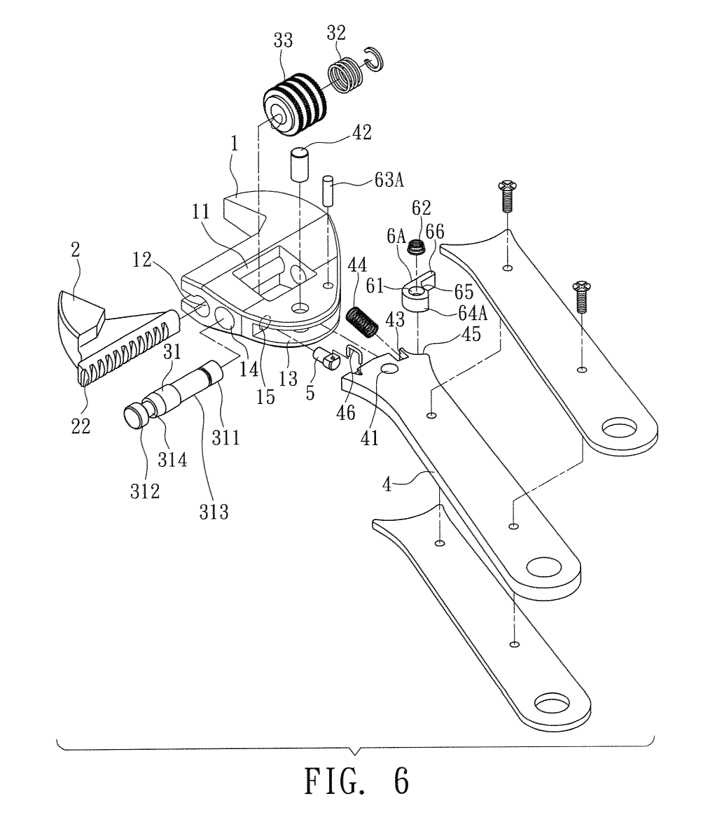

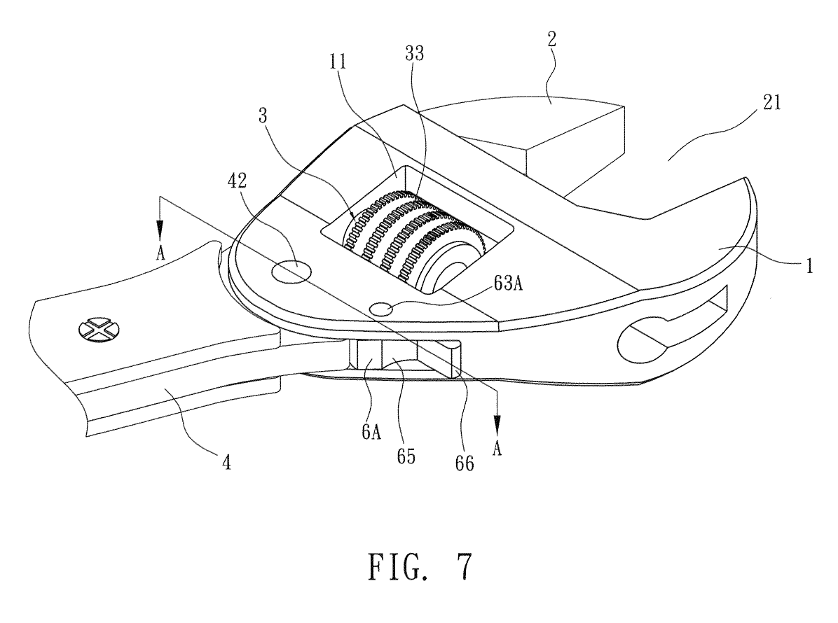

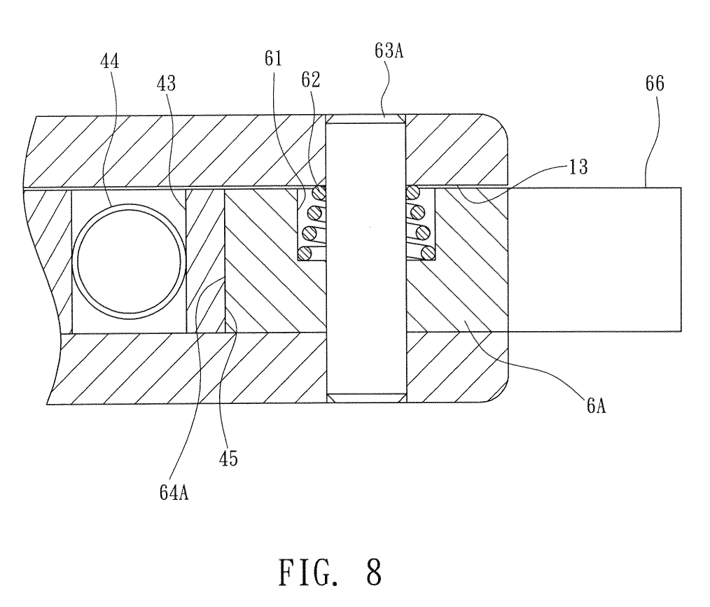

Please refer to FIGS. 6 to 8 for a second embodiment of the invention. It differs from the first embodiment in that the fixing element 6A has a concave part 61 on its end surface for accommodating an elastic element 62. As shown in FIG. 8, the fixing element 6A is accommodated on one side of the pivotal groove 13 of the fixing jaw 1. A pin 63A goes from the outer side of the pivotal groove 13 into the concave part 61 of the fixing element 6A. The elastic element 62 urges between the inner wall of the pivotal groove 13 and the concave part 61. The fixing element 6A is thus pivotally disposed in the pivotal groove 13 and opposite to the fixing part 45 of the handle 4. A limiting section 64A with a shape corresponding to that of the fixing part 45 of the handle 4, a slightly recessed moving section 65, and a protruding pushing part 66 are formed around the fixing element 6A. The user can push the pushing part 66 to rotate the fixing element 6A, so that the fixing element 6A selectively uses its limiting section 64A or moving section 65 to face the fixing part 45 of the handle 4. In this embodiment, the fixing part 45 of the handle 4 has a curved recessing surface, while the limiting section 64A has a curved protruding surface. Therefore, when the fixing part 45 of the handle 4 and the limiting section 64A of the fixing element 6A are engaged, the contact between the two curved surfaces provides the required locking effect. Such a configuration can effectively resist the torque produced by the swing of the handle 4.

When the limiting section 64A of the fixing element 6A faces the fixing part 45 of the handle 4, they are engaged so that the handle 4 is restricted by the limiting section 64A not to swing. Moreover, when the position of the fixing element 6A is adjusted so that the limiting section 64A and the fixing part 45 of the handle 4 move away from each other and the moving section 65 faces the fixing part 45 of the handle 4, a swing space 7A for the handle 4 to swing with respect to the fixing jaw 1 is formed between the fixing part 45 of the handle 4 and the moving section 65 of the fixing element 6A.

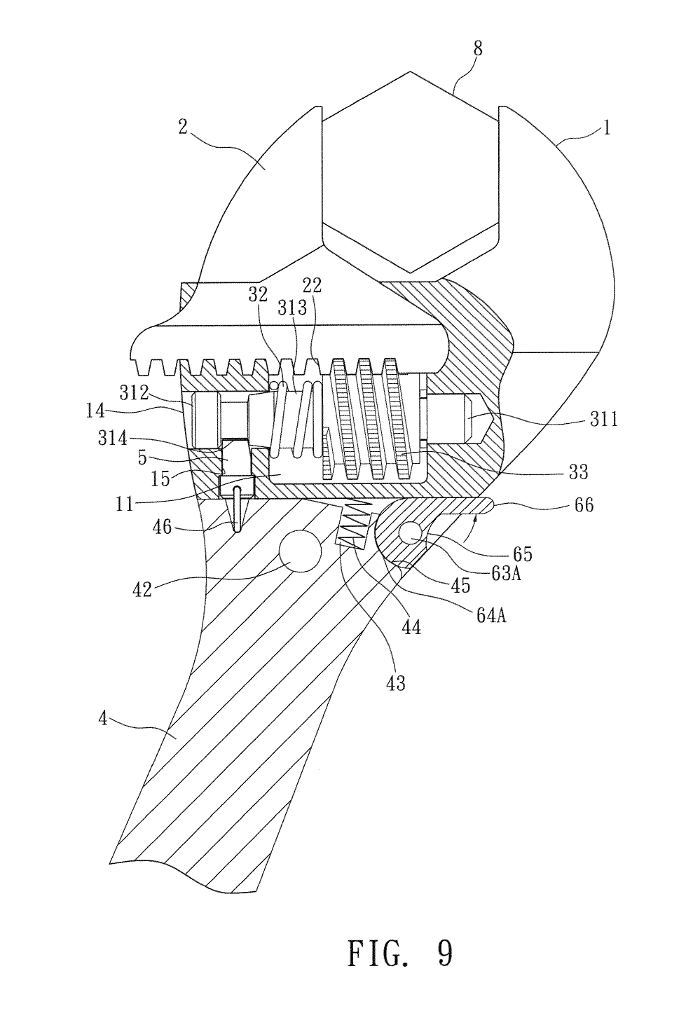

Please refer to FIG. 9. When the user pushes the pushing part 66 of the fixing element 6A so that the limiting section 64A of the fixing element 6A engages with the fixing part 45 of the handle 4, the front end of the handle 4 is restricted by the limiting section 64A of the fixing element 6A so that the handle 4 cannot swing with respect to the fixing jaw 1. This also enables the embodiment to have the features of the traditional wrench.

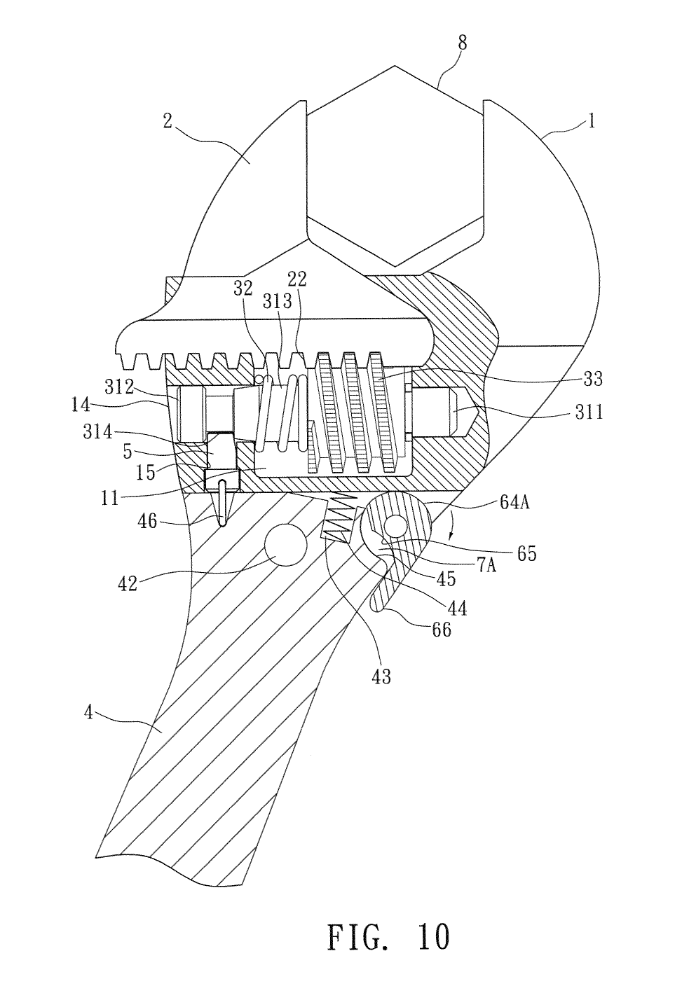

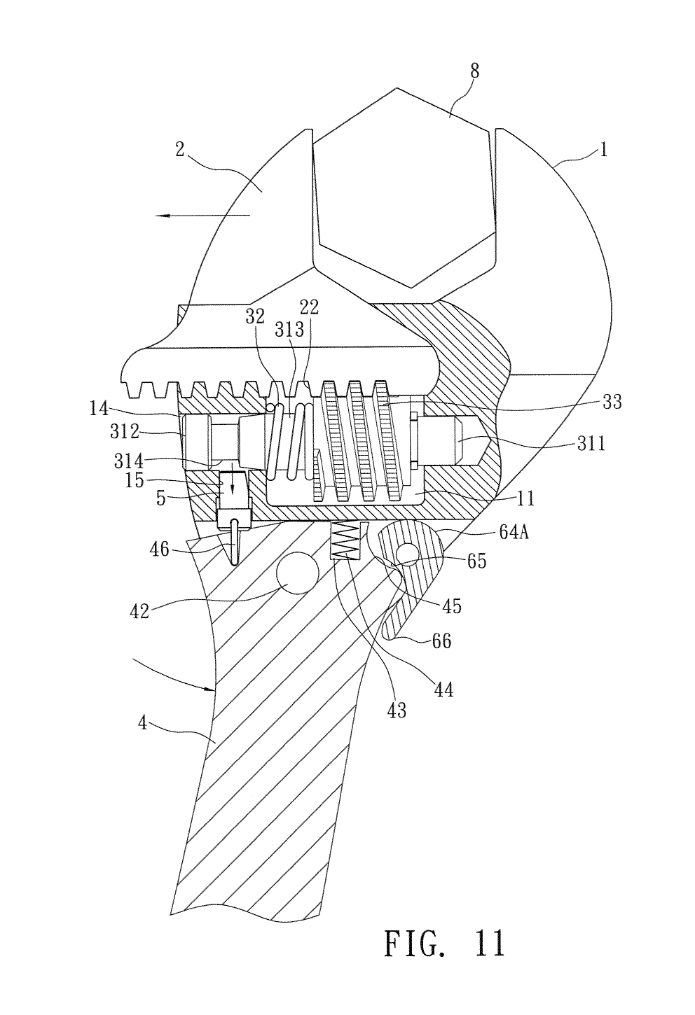

When the user pushes the pushing part 66 of the fixing element 6A so that the moving section 65 of the fixing element 6A faces the fixing part 45 of the handle 4 and the limiting section 64A moves away from the fixing part 45 of the handle 4, as shown in FIG. 10, a swing space 7A for the handle 4 to swing with respect to the fixing jaw 1 is formed between the fixing part 45 of the handle 4 and the moving section 65 of the fixing element 6A. Therefore, when the user uses the pivotal axis 42 at the front end of the handle 4 as a pivot and rotates the wrench 4 in reverse, as shown in FIG. 11, the handle 4 can swing toward the swing space 7A. In this case, the swing wrench in this embodiment achieves the feature of locking or unlocking a polygonal bolt in a continuous way.

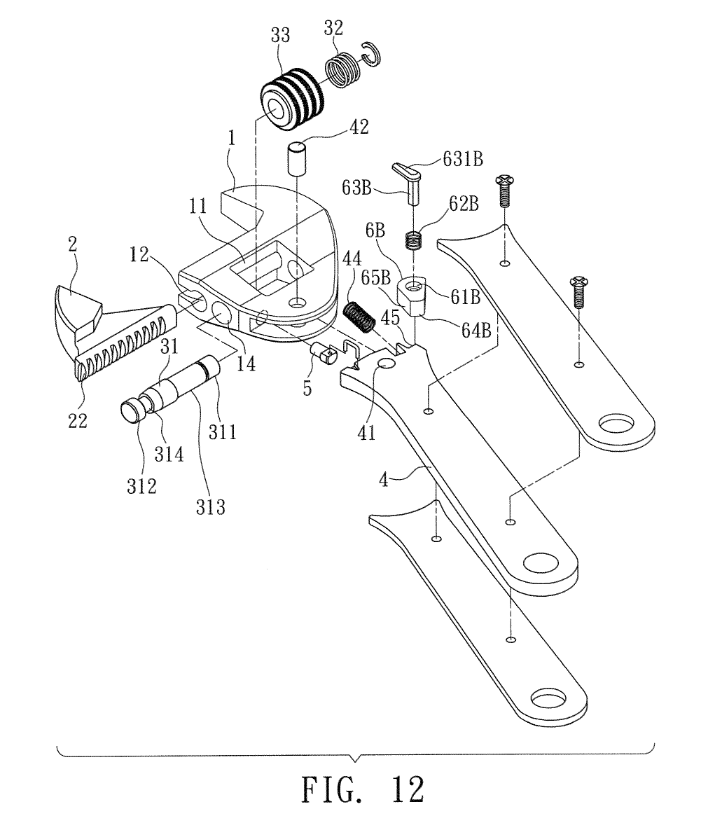

FIG. 12 shows a third embodiment of the invention. It differs from the above-mentioned two embodiments in that the limiting section 64B and the moving section 65B are formed around the fixing element 6B. One end of the pin 63B goes from the outer side of the pivotal groove 13 into the concave part 61B of the fixing element 6B, thereby connecting to the fixing element 6B. The other end of the pin 63B bends outward to form an exerting part 631B. When the user applies a force on the exerting part 631B, it brings the fixing element 6B into rotation simultaneously. The fixing element 6B can selectively use its limiting section 64B or the moving section 65B to face the fixing part 45 of the handle 4.

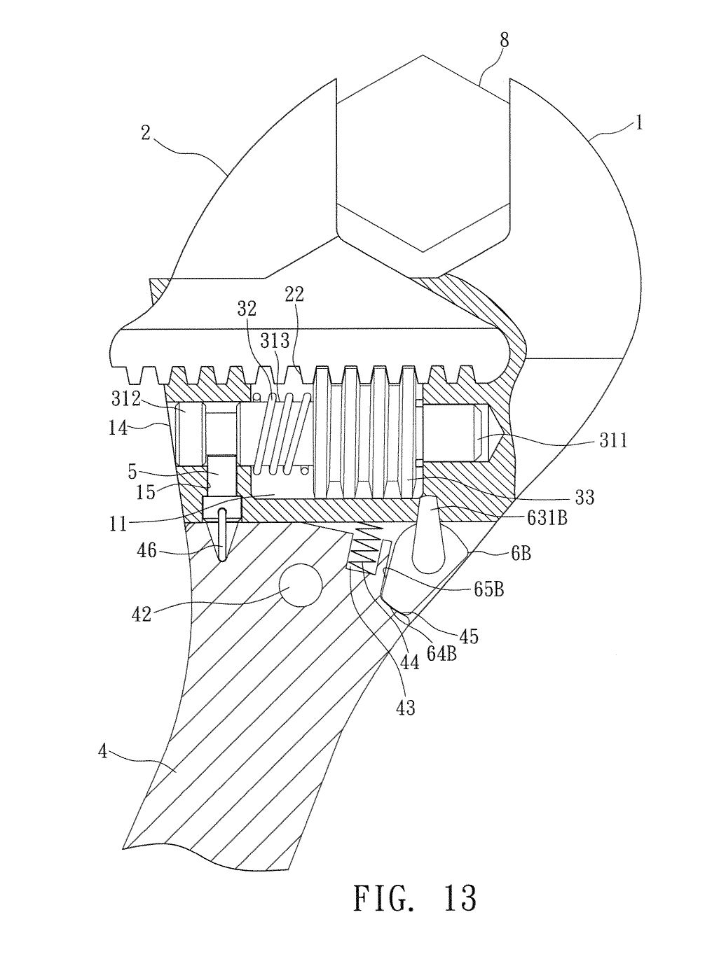

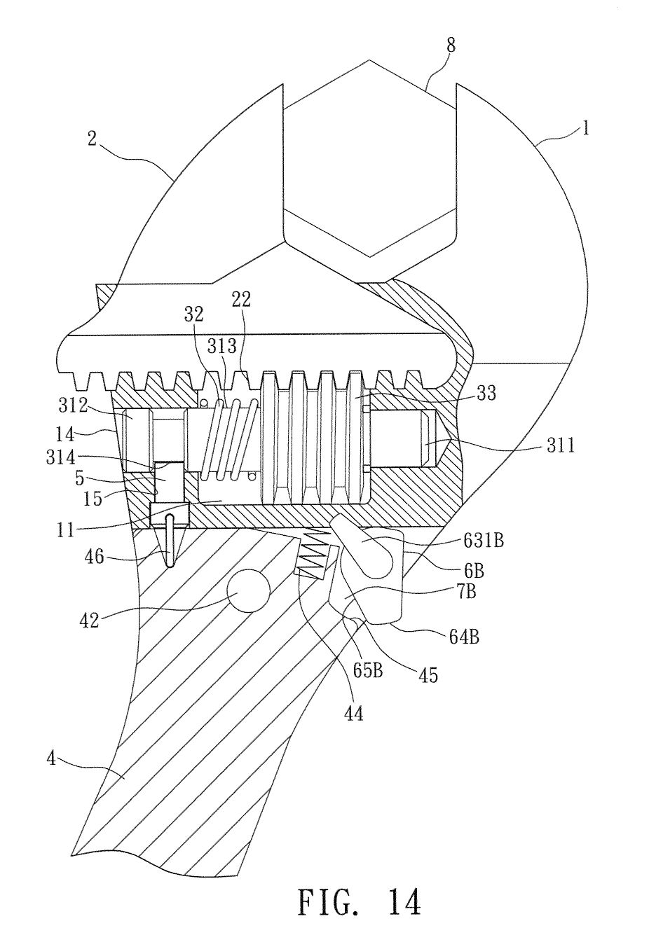

As shown in FIG. 13, when the user rotates the exerting part 631B so that the limiting section 64B faces the fixing part 45 of the handle 4, they are engaged to prevent the handle 4 from swinging. When the user rotates the exerting part 631B so that the limiting part 64B of the fixing element 6B moves away from the fixing part 45 of the handle and the moving section 65B faces the fixing part 45, as shown in FIG. 14, a swing space 7B for the handle 4 to swing with respect to the fixing jaw 1 is formed between the fixing part 45 of the handle 4 and the moving section 65B of the fixing element 6B.

In summary, the disclosed swing wrench achieves the goal of having both traditional and one-way driving features by adjusting the position of the fixing element 6. Not only is it easy to operate, its simple structure also makes the assembly and machining relatively convenient.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A swing wrench comprising a fixing jaw, a moving jaw, an acting set, a handle pivotally fixed to the bottom of the fixing jaw, and a stopping pin, with the fixing jaw having an accommodating tank, a sliding track being disposed above and in communication with the accommodating tank, one side of the accommodating tank being formed horizontally with a through hole, a connecting hole being formed in the radial direction inside the through hole, the moving jaw being disposed in the sliding track of the fixing jaw to slide sideways therein, a tooth part being formed at the bottom of the moving jaw, the acting set being disposed in the accommodating tank of the fixing jaw and including a shaft and a spring, the shaft having a first end, a second end, and a middle section between the first end and the second end, the part between the middle section and the second end being slightly recessed to form a stopping part, the second end of the shaft and the stopping part being inserted into the through hole of the fixing jaw, the stopping part corresponding to the connecting hole, a roller being mounted on the middle section of the shaft and matching with the tooth part at the bottom of the moving jaw, the spring being mounted around the middle section of the shaft with both ends urging against the roller and the inner wall of the accommodating tank, the stopping pin being disposed in the connecting hole of the fixing jaw with one end connecting to the front end of the handle so that when the front end of the handle rotates with respect to the fixing jaw the front end of the handle drives the stopping pin to slide, rendering the other end of the stopping pin to selectively block the stopping part of the shaft, characterized in that:
one side at the front end of the handle is formed with a fixing part, a fixing element is disposed between the bottom of the fixing jaw and the fixing part of the handle, the fixing element has at least one limiting section to engage or disengage the fixing part of the handle, and when the limiting section disengages the fixing part a swing space is formed between the fixing part of the handle and the fixing element.

2. The swing wrench of claim 1, wherein a pivotal groove is formed at the bottom of the fixing jaw, the front end of the handle is pivotally disposed in the pivotal groove, the fixing element is accommodated on one side of the pivotal groove, a fixing hole is formed on the end surface of the fixing element, a sliding groove is formed outside the bottom of the fixing jaw opposite to the fixing hole, a pin goes from the sliding groove outside the pivotal groove into the fixing hole of the fixing element, and the fixing element is driven by the pin to engage or disengage the fixing part of the handle along the sliding groove.

3. The swing wrench of claim 2, wherein the two adjacent planes of the fixing element opposite to the fixing part are formed with a limiting section whose shape matches with that of the fixing part of the handle.

4. The swing wrench of claim 2, wherein a pushing part is formed on the outer side of the pin that faces the fixing jaw.

5. The swing wrench of claim 1, wherein the front end of the handle has a shaft hole, a pivotal axis is pivotally inserted at the bottom of the fixing jaw so that the handle swings along an arc curve to expand or collapse.

6. The swing wrench of claim 5, wherein a concave groove is formed on the side of the front end of the handle opposite to the pivotal axis for accommodating an elastic object that urges against the bottom of the fixing jaw using its one end.

7. The swing wrench of claim 1, wherein a pivotal groove is formed at the bottom of the fixing jaw, the front end of the handle is pivotally disposed in the pivotal groove, the fixing element is accommodated on one side of the pivotal groove, a concave part is formed on the end surface of the fixing element for accommodating an elastic element, a pin goes from the outer side of the pivotal groove into the concave part of the fixing element, the elastic element urges against the inner wall of the pivotal groove and the concave part so that the fixing element is pivotally disposed in the pivotal groove and opposite to the fixing part of the handle.

8. The swing wrench of claim 7, wherein the limiting section, a moving section and a pushing part are formed around the fixing element so that the user pushes the pushing part to make the limiting section or the moving section oppose to the fixing part of the handle.

9. The swing wrench of claim 8, wherein the fixing part and the limiting section have corresponding shapes, the fixing part having a curved recessing surface and the limiting section having a curved protruding surface, so that when the fixing part and the limiting section are engaged the two curved surfaces together restricts the swinging of the handle.

10. The swing wrench of claim 8, wherein the and le section of the fixing element is recessed and, when the moving section of the fixing element is opposite to the fixing part of the handle, a swing space is formed between the fixing part and the fixing element for the handle to swing with respect to the fixing jaw.

11. The swing wrench of claim 1, wherein a pivotal groove is formed at the bottom of the fixing jaw, the front end of the handle is pivotally disposed in the pivotal groove, the fixing element is accommodated on one side of the pivotal groove, a concave part is formed on the end surface of the fixing element for accommodating an elastic element, a pin goes from the outer side of the pivotal groove into the concave part of the fixing element, the elastic element urges against the inner wall of the pivotal groove and the concave part, and one end of the pin connects to the fixing element and its other end bend outwards to form a pushing part.
